(19) United States
(12) Patent Application Publication
(10) Pub. No.: US 2013/0122870 A1
(43) Pub. Date: May 16, 2013

(54) METHOD FOR MANAGEMENT OF A VOICE MAILBOX PHONE

(71) Applicants: Prasanna Hegde, Singapore (SG); Chan Keng Kun, Singapore (SG); Michael Jim Tien Chan, Singapore (SG)

(72) Inventors: Prasanna Hegde, Singapore (SG); Chan Keng Kun, Singapore (SG); Michael Jim Tien Chan, Singapore (SG)

(73) Assignee: GEMALTO SA, Meudon (FR)

(21) Appl. No.: 13/520,183

(22) PCT Filed: Aug. 10, 2010
(86) PCT No.: PCT/EP2010/061599

§ 371 Date: Nov. 20, 2012

(30) Foreign Application Priority Data
Dec. 31, 2009 (EP) 09291005.8

(51) Int. Cl. H04W 4/12

(52) U.S. Cl. CPC H04W 4/12
USPC 455/412.2; 455/413

(57) ABSTRACT

The invention relates to a method for managing a voice mailbox on a voice mailbox server comprising the steps of getting (S_GET_VOICE_MSG) voice mail data (VOICE_MSG), getting (S_GET_SNDR_ID) a Sender Identification (SNDR_ID), and getting (S_GET_INFO_CALL) at least one characterizing information about the call (INFO_CALL).

### FIELD OF THE INVENTION

This invention relates to a method for managing a voice mailbox on a voice mailbox server.

According to another aspect, the invention relates to a token adapted to manage a voice mailbox and a voice mail box server adapted to manage its voice mailbox.

### BACKGROUND OF THE INVENTION

Voicemail has the sole purpose of storing voice messages from someone trying to call a user's mobile phone when that user is otherwise unavailable and then relaying those messages to the user when convenient.

But today's voicemail systems, particularly for mobile phones, fail to do this intelligently.

The primary reason is the nature of the interface from the user's communication device to the remote voice mailbox server: typically, a communication device user will call (or be called by) a voice mailbox server controlled by the network operator. The voice mailbox server will generate a synthetic voice announcing the number of messages to the user and then replaying the messages; various options are then spoken by the synthetic voice, such as “press 1 to reply”, “press 2 to delete”, “press 3 to repeat” etc.

Another reason is the nature of the list of messages. The messages queue in the order they were received by the voice mailbox server, and the first message to be replayed to the user is the first message that was received.

That is to listen to the fifth message, the user should listen to the four messages that were received by the voice mailbox server earlier.

This presents several challenges to the user:
first, he may not have a pen and paper to hand to take down any important information;
secondly, he may forget or not be able to hear the options and hence will be unable to operate the voicemail system effectively;
thirdly, he may not be able to replay a single message without replaying messages received by the voice mailbox server earlier than this message. When he wants to listen again to a message, he should play previous messages first, that amounts in an increase of delay and more communication time spent.

Because of this inadequate and opaque interface, voicemail is not used by at least 45% of mobile phone users. Of those that do use voicemail, it typically accounts for 30% of a user's call time and spend.

It is an object of the invention to provide a method for managing a voice mailbox more effectively and intelligently, and in particular to provide a method that allows the user to sort his voicemails in a more convenient way.

Thereto, the present invention provides a method for managing a voice mailbox on a voice mailbox server comprising the steps of getting voice mail data, getting a Sender Identification, and getting at least one characterizing information about the call.

Further, the method can comprise the step of combining information of the Sender Identification and the characterizing information with the voicemail data.

According to one aspect, such combining of information can be made in a common file, such as a database, and stored in a non volatile memory of the voice mailbox server and/or of the token.

According to another aspect, the characterizing information about the call can comprise an urgency level of the call.

Such characterizing information about the call may also comprise the subject of the call (C_SUBJECT).

According to a yet further aspect, upon reception of a notification message from a receiver communication device it is inserted in, the method makes a token execute a voicemail management applet in which a message to be displayed on the receiver communication device is created, the message comprising at least the sender identification, at least one characterizing information about the call.

In yet another aspect, the method may further comprise the step of having the voice mailbox server send to a receiver communication terminal a notification message that comprises a Voicemail Profile field and a Voicemail Notification field.

Further, the Voicemail Profile field may comprise the Sender Identification and at least one characterizing information about the call.

The invention also relates to a token for managing a voice mailbox comprising a non volatile memory and an input/output communication port for communicating with a receiver communication terminal through an interface link wherein upon reception upon reception of a notification message, the method according to the invention is run on processing means of said token.

The invention also relates to a voicemail box server for managing a voice mailbox adapted to get voice mail data, to get a Sender Identification, and to get at least one characterizing information about the call.

The various aspects, features and advantages of the invention will become more fully apparent to those having ordinary skill in the art upon careful consideration of the following Detailed Description thereof with the accompanying drawings described below:

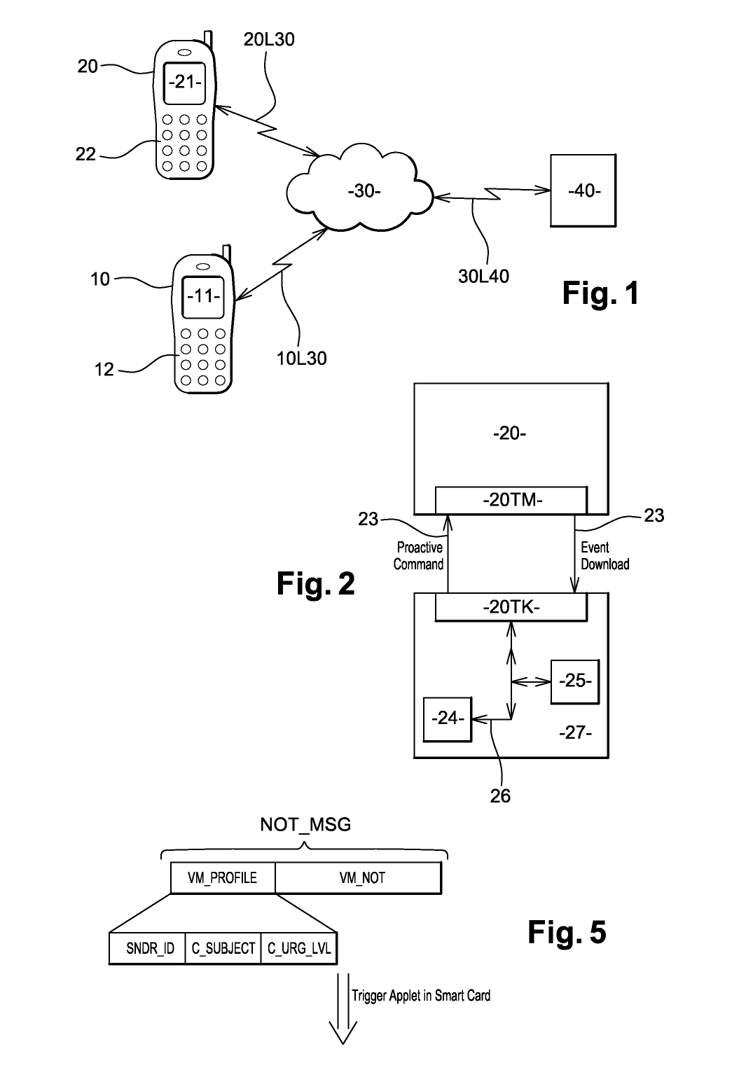

FIG. 1 depicts a simplified schematic drawing of a call-maker communication device and a receiver communication device operatively connected to a voicemail server through a communication network;

FIG. 2 depicts the connections between the receiver communication device with its token;

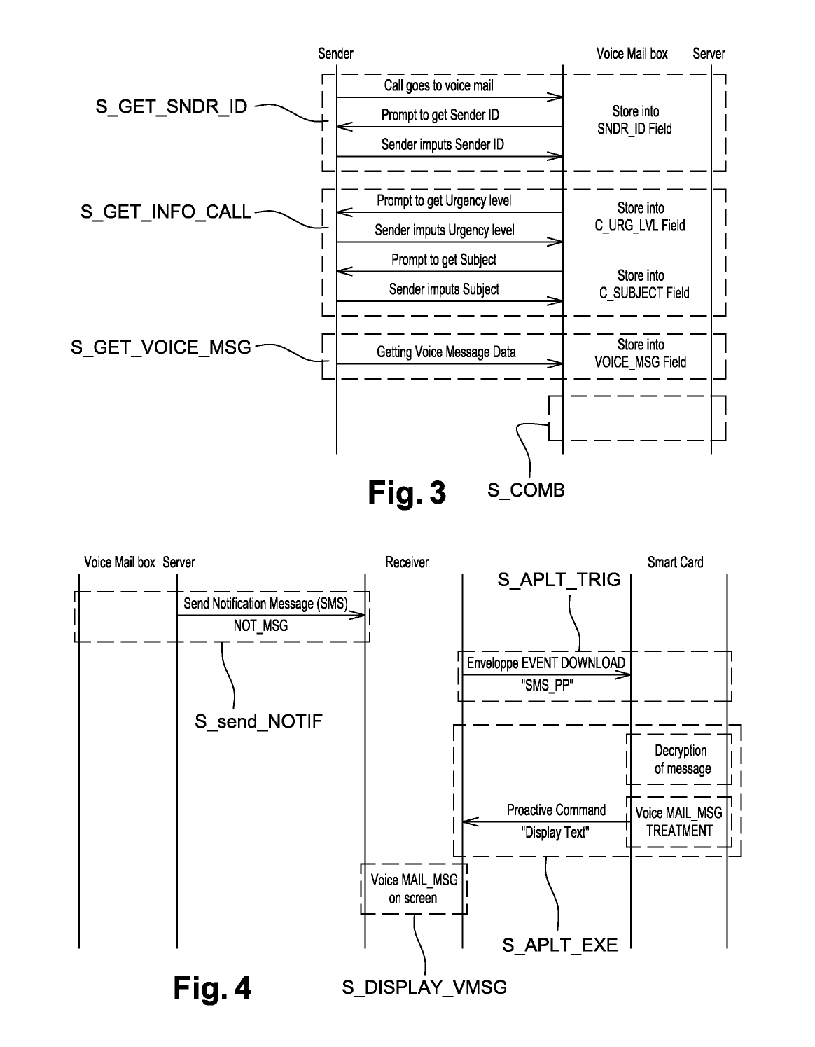

FIG. 3 shows the data flow occurring between the sender communication device and the voice mailbox server;

FIG. 4 shows the data flow occurring between the voice mail server, the receiver communication device and its token;

FIG. 5 depicts the notification message format according to the invention.

### DETAILED DESCRIPTION

Referring to the figures and for the moment in particular to FIG. 1, a sender communication device 10 and a receiver communication device 20 are operatively connected to a voice mailbox server 40 through a communication network 30.

The voice mailbox server 40 refers in the following specification, to an electronic device including at least one data processing and controlling means and at least one memory hosting at least one applicative software that is accessible from outside.

The voice mailbox server 40 is used to process, manage and broadcast the voicemails that are sent from the sender communication device 10 to the receiver communication device 20. Further, this voice mailbox server 40 is able to store voice messages and check authenticity of the messages.

The voice mailbox server 40 can be connected to the communication network 30 through a wire or a wireless link 30L40.

The communication network 30 can be a private or a public network and can be connected to the communication devices 10, 20 through wire or wireless bidirectional links.

In the following, we will assume that the links 10L30, 20L30 between the communication devices 10,20 and the communication network 30 are radiofrequency wireless links.

The sender 10 and receiver 20 communication devices respectively provide screens 11, 21 for displaying information to either the sender or the receiver and keypads 12, 22 for having the sender or the receiver type in messages or instructions.

The communication device 10, 20 can be handsets or cellular phones, personal digital assistants (PDA) or wireless enabled laptops or notebook computers, etc.

Referring now to FIG. 2, the receiver communication device 20 comprises a token 27 that is coupled by way of a contact or of a contactless communication interface link 23.

The token 27 can be chosen amongst a GSM Subscriber Identity Module (SIM) smart card, or a Universal Subscriber Identity Module (USIM) smart card, or some other removable module on which user specific information is stored such as a dongle device, a USB (Universal Serial Bus), SD (Secure Digital), or MMC (Multi-Media Card) device.

In the following invention, a token should be understood as an electronic device having data processing and controlling means and means for communicating in at least the outward direction for example towards the mobile electronic device, such as a handset, housing the token.

In the following illustrative embodiments, the receiver communication device 20 is a handset and the token is a removable smart card of the SIM or USIM type. Further, the handset 20 comprises a smart card reader according to the ISO 7816 standard adapted to have a smart card 27 inserted therein, via a contact interface link 23.

In the following described embodiments, the exemplary SIM or USIM smart card 27 includes tool kit applications, e.g., the SIM Toolkit Application, with commands that permit the card to initiate actions and perform operations or request information, etc. . . . from the receiver communication device 20 through a input/output communication port means 20TM.

The smart card 27 comprises at least one non-volatile memory 24, a data processing means 25 and input/ouput communication port means 20TK, each of these means being coupled to each other by a communication internal data bus 26.

Thus, applets stored in the non-volatile memory 24 can be transferred through the communication internal data bus 26 to the processing means 25 and run. Upon execution, the applets on the smart card 27 can use SIM Toolkit Application features, such as Proactive Commands and Event Downloads, to communicate with the receiver handset 20 through their respective input/output communication ports 20TK and 20TM.

According to the invention, the method of managing a voice mailbox on a voice mailbox server includes some interactions between the sender communication device 10 and the voice mailbox server 40, some of which are disclosed in FIG. 3.

A first subscriber, the sender, using a sender communication device 10 operates a phone call to a second subscriber, the receiver, using a receiver communication device 20.

The sender is not connected to the receiver and the phone call goes to the voice mailbox. Thus, the sender communication device 10 is connected to the voice mailbox server 40.

First Step (S_GET_SNDR_ID):

Getting the Sender Identification SNDR_ID.

In a first step S_GET_SNDR_ID, the voice mailbox server 40 acquires the Sender Identification SNDR_ID, for example the sender communication device 10 phone number, or the name of the sender.

If the sender uses a communication device that automatically transfers its phone number, then the Sender Identification SNDR_ID is preferably the phone number.

If the sender uses a communication device that does not automatically transfer its phone number, for example because, he used a public phone, then, the voice mailbox server 40 sends a request to the sender communication device 10 for having Sender Identification SNDR_ID sent to him.

In response, the sender inputs its Sender Identification SNDR_ID to the voice mailbox server 40.

This Sender Identification SNDR_ID can be sent in writing using the keypad 12 or spoken by the sender in the sender communication device 10.

In the latter, the voice mailbox server 40 has voice recognition features to exchange information with the sender through speech. Thus, the server 40 comprises a vector or voice interpreter for converting voice to text and text to voice for interacting with the sender. Further, the server 40 comprises a voice analyser to analyse whether the voice message input by the sender is correct or not.

For Example:

Joe, the sender, initiates a call and tries to call his friend, the receiver, which goes to voice mail.

Server: “Please input your Name/ID”, i.e. the Sender Identification SNDR_ID, (as you are calling from an unknown post).

Sender: “Joe”

Logic:
S1: The voice interpreter outputs a text format of the sender's name;
S2: Sender's name again goes through the voice interpreter to output voice from server to Joe, to get confirmation;
S3: Server will prompt “Joe” (name/ID) is correct?;
S4: Sender verifies by inputting a response;
S5: If interpreted name/ID, i.e. sender identification SNDR_ID, is not correct then the server loops through for sender to speak the name/ID again.

In case the server fails to interpret correctly sender Identification SNDR_ID, for example because the sender has a different pronunciation than that of the voice interpreter capability; then the logic could loop for a predetermined number of times, for example three times. If the interpretation is still not successful, then the voice interpreter could send a request to the server 40 to send a mail for further investigation of the result of voice interpretation to a support team.

In a preferred embodiment, the voice mailbox server 40 may comprise sender authentications means, for example a Hardware Security Module (HSM).

The HSM on the server 40 may prompt for authentication from the sender communication device 10. If the authentication is valid, then the HSM in the server 40 may accept the sender leave a voice mail.

Once, the Sender Identification SNDR_ID is inputted into the voice mailbox server 40, it is stored in a memory of the voice mailbox server 40.

Second Step (S_GET_INFO_CALL):

Getting at least one characterizing information about the call (INFO_CALL).

In a second step S_GET_INFO_CALL, the voice mailbox server 40 acquires at least one characterizing information about the call INFO_CALL.

In the depicted embodiment, this characterizing information INFO_CALL comprises an urgency level of the call C_URG_LVL and a subject of the call C_SUBJECT.

It is foreseen that some additional characterizing information INFO_CALL could be acquired by the voice mailbox server 40.

The voice mailbox server 40 sends a request to the sender communication device 10 for having the characterizing information INFO_CALL corresponding to the voicemail message the sender wants to leave on the voice mailbox server 40.

In this embodiment, the voice mailbox server 40 prompts successively, the sender communication device 10 for an urgency level of the call C_URG_LVL and a subject of the call C_SUBJECT.

In response, the sender inputs the urgency level of the call C_URG_LVL and the subject of the call C_SUBJECT to the voice mailbox server 40.

This characterizing information INFO_CALL can be sent in writing using the keypad 12 or spoken by the sender in the sender communication device 10.

In the latter, the voice mailbox server 40 may use voice recognition capabilities as described earlier in first step.

Once, the characterizing information INFO_CALL is inputted into the voice mailbox server 40, then it is stored in a memory of the voice mailbox server 40.

Third Step (S_GET_VOICE_MSG):

Getting the voicemail data (VOICE_MSG).

In a third step S_GET_VOICE_MSG, the voice mailbox server 40 acquires the voicemail data VOICE_MSG, that is to say it acquires the message from the sender.

The sender inputs its voicemail data VOICE_MSG, preferably by speaking into the sender communication device 10.

Once, the sender has finished speaking, then the voicemail data VOICE_MSG is stored in a memory of the voice mailbox server 40.

If the voicemail data VOICE_MSG comprises silence or non-voice backgrounds or parts, then the voicemail data VOICE_MSG can be truncated before being stored in the memory, for providing better use of the memory space.

Fourth Step (S_COMB):

Combining the Sender Identification (SNDR_ID) and the characterizing information (INFO_CALL) with the voicemail data (VOICE_MSG).

The information relating to the voice mail that is collected from the sender is preferably combined in a common file and stored on the voice mailbox server 40.

This file could be a database as follows:

| | | | | Preferred Field |
|---|---|---|---|---|
| | | INFO_CALL | | Preferred |
| MSG ID | SNDR_ID | C_URG_LVL | C_ SUBJECT | SNDR ID |
| 1 | 1234567 | very urgent | Need Help | Yes |
| 2 | 5678988 | Very urgent | Urgent Matter | No |
| 3 | Joe | urgent | Urgent Request | No |
| 4 | John | not urgent | Greeting | No |

This database contains the information gathered by the server: Sender Identification SNDR_ID, the urgency level of the call C_URG_LVL and the subject of the call C_SUBJECT. In addition, the database can comprise a Preferred Field P_F, that is in the example shown in the table above, a Preferred SNDR_ID.

The Preferred SNDR_ID can be sent by the receiver to the voice mailbox server 40 through an SMS message sent by a voicemail management applet APLT in the smart card 27.

Thus, it is possible to sort the list of voice mails in the database according to any field. Preferably, as shown in the table above, voice mails are sorted according to the Urgency Level C_URG_LVL first and then by the Preferred SNDR_ID. Further, any other voice mail that is not marked by C_URG_LVL and Preferred SNDR_ID is not sorted.

Further, the sorting of the list of voice mails is done according to two groups of lists of voice mails. Thus, first the list of unread voice mails is sorted, then the list of read voice mails is sorted. Both lists can be sorted according to the same criteria.

An Elementary File (EF) called EF_VoiceMail could be maintained and synchronised with the information of this database in the non-volatile memory 24 of the smart card 27. Thus, the smart card 27 is able to do the same operations than the voice mailbox server 40, and spare some computing resources on the server 40.

Once, the voice mailbox server has acquired all information needed in relation with the voice mail left by the sender to the receiver, the voice mailbox server will inform the receiver, a voice mail has been left on his voice mailbox.

FIG. 4 shows the data flow occurring between the voice mail server, the receiver communication device and its token.

Fifth Step (S_SEND_NOTIF):

Sending a notification message (NOT_MSG) by the voice mailbox server to the receiver communication device.

Voice mail notification messages are special SMS (Short Message Service) messages or emails that are used to tell the user that they have voice mail waiting in the voice mailbox.

On most communication devices, the phone displays a message prompt, and the receiver can press a single key to be transferred the voice mail stored in his voice mailbox.

Thus, the voice mailbox server 40 sends an SMS or has an SMS sent (by a SMS server for example) to the receiver communication device 20 in a step S_SEND_NOTIF.

According to a preferred embodiment of the invention depicted in FIG. 5, the notification message NOT_MSG will have an enriched header field to carry an enriched voicemail profile VM_PROFILE and a voice mail notification field VM_NOT. The latter can be the field typically used to notify the receiver of a new voice mail.

The enriched voicemail profile VM_PROFILE comprises a plurality of fields that allows transferring the information gathered from the sender relating to the voice mail. As described in FIG. 5, the enriched voicemail profile VM_PROFILE comprises a field for the sender identification SNDR_ID, a field for the subject of the voice mail C_SUBJECT and last a field for the urgency level of the voice mail C_URG_LVL.

The voice mailbox server 40 can comprise a Secure Access Machine (SAM), that permits to transmit data to the smart card 27 and in particular the notification message NOT_MSG in a secured environment.

Sixth Step (S_APLT_TRIG):

The receiver communication device 20 triggers a voicemail management applet (APLT) in the smart card 27 via the notification message NOT_MSG.

Upon reception of the notification message NOT_MSG, the receiver communication device 20 triggers a voicemail management applet APLT in the smart card 27 in a step S_APLT_TRIG.

The smart card can be notified by using the Enveloppe (EVENT DOWNLOAD-SMS-PP) command.

Seventh Step (S_APLT_EXE):

The smart card executes the voicemail management applet APLT.

Upon notification, the data processing means 25 of the smart card 27 executes the voicemail management applet APLT.

The voicemail management applet APLT may first decrypt the message. This may be done using a Hardware Security Module (HSM) emulated by a pseudo SIM provided by smartcard-like applications and protocols, i.e. giant SIM as the HSM (GEM 2144).

Then, the voicemail management applet APLT may create a voice mail message VOICE_MAIL_MSG to be displayed on the screen 21 of the receiver communication device to inform the receiver and make some treatment of the information to be displayed in a VOICE_MAIL_MSG_TREATMENT task.

In this task, the called EF_VoiceMail Elementary File stored in the non-volatile memory 24 of the smart card 27 can be sorted by the voicemail management applet APLT as disclosed in connection at the voice mail box server 40 side. This sorting of the voice mail messages may be a default sorting, for example by sorting the messages by their level of urgency, or a receiver-defined sorting.

In addition to regular information that is displayed to the receiver, this voice mail message VOICE_MAIL_MSG will show additional information: the sender identification SNDR_ID, the subject of the voice mail C_SUBJECT and the urgency level of the voice mail C_URG_LVL.

The smart card will send a Display Text proactive command to the receiver communication device 20 for displaying the voice mail message VOICE_MAIL_MSG.

Eight Step (S_DISPLAY_VMSG):

The receiver communication device displays the voice mail message VOICE_MAIL_MSG received from the smart card.

Upon reception, the receiver communication device 20 displays the voice mail message VOICE_MAIL_MSG on its display 21.

Thus, the receiver can rapidly and efficiently take notice of a voice mail. Moreover, the receiver may not miss an urgent voice mail, using the urgency level information, or an important voice mail, using the subject information.

While the present invention and the best modes thereof have been described in a manner establishing possession by the inventors and enabling those of ordinary skill to make and use the same, it will be understood and appreciated that there are equivalents to the exemplary embodiments disclosed herein and that modifications and variations may be made thereto without departing from the scope and spirit of the invention, which is to be limited not by the exemplary embodiments but by the appended claims.

In particular, it should be apparent to those of ordinary skill that the sorting of the list of message can be done in the receiver communication device instead or in addition of being done in the smart card or the server.

1. A method for managing a voice mailbox on a voice mailbox server comprising the steps of:
getting (S_GET_VOICE_MSG) voice mail data (VOICE_MSG),
getting (S_GET_SNDR_ID) a Sender Identification (SNDR_ID),
getting (S_GET_INFO_CALL) at least one characterizing information about the call (INFO CALL).

2. The method for managing a voice mailbox according to claim 1 further comprising the step of combining information (S_COMB) the Sender Identification (SNDR_ID) and the characterizing information (INFO CALL) with the voicemail data (VOICE_MSG).

3. The method for managing a voice mailbox according to claim 2 in which the information is combined in a common file, such as a database, and stored in a non-volatile memory of the voice mailbox server (40) and/or of the token (27).

4. The method for managing a voice mailbox according to any one of claims 1 to 3, wherein the characterizing information about the call (INFO CALL) comprises a urgency level of the call (C URG LVL).

5. The method for managing a voice mailbox according to any one of claims 1 to 3, wherein the characterizing information about the call (INFO CALL) comprises the subject of the call (C_SUBJECT).

6. The method for managing a voice mailbox according to any one of claims 1 to 3 wherein upon reception of a notification message (NOT MSG) from a receiver communication device (20) a token (27) is inserted in, the token (27) executes a voicemail management applet (APLT) in which a message (VOICE MAIL MSG) to be displayed on the receiver communication device (20) is created, the message comprising at least the sender identification SNDR ID, at least one characterizing information about the call (INFO CALL).

7. The method for managing a voice mailbox according to claim 1, further comprising the step (S_SEND_NOTIF) of having the voice mailbox server (40) send to a receiver communication terminal (20) a notification message (NOT MSG) that comprises a Voicemail Profile field (VM_PROFILE) and a Voicemail Notification field (VM_NOT).

8. The method for managing a voice mailbox according to any one of claims 1 to 3, wherein the Voicemail Profile field (VM Profile) comprises the Sender Identification (SNDR ID) and at least one characterizing information about the call (INFO_CALL).

9. A token (27) for managing a voice mailbox comprising a non volatile memory (25) and an input/output communication port (20TK) for communicating with a receiver communication device terminal (20) through an interface link (23) wherein upon reception upon reception of a notification message (NOT MSG), comprising instructions to cause said token (27) to execute a method comprising:
getting (S_GET_VOICE_MSG) voice mail data (VOICE_MSG),
getting (S_GET_SNDR_ID) a Sender Identification (SNDR_ID),
getting (S_GET_INFO_CALL) at least one characterizing information about the call (INFO CALL).

10. A voicemail box server (40) for managing a voice mailbox adapted to get (S_GET_VOICE_MSG) voice mail data (VOICE_MSG), to get (S_GET_SNDR_ID) a Sender Identification (SNDR_ID), and to get (S_GET_INFO_CALL) at least one characterizing information about the call (INFO_CALL).

11. The token (27) of claim 9 wherein the method further comprises the step of combining information (S_COMB) the Sender Identification (SNDR_ID) and the characterizing information (INFO CALL) with the voicemail data (VOICE_MSG).

12. The token (27) of claim 11 in which the information is combined in a common file, such as a database, and stored in a non-volatile memory of the voice mailbox server (40) and/or of the token (27).

13. The token (27) of claim 9, 11, or 12 wherein the characterizing information about the call (INFO CALL) comprises an urgency level of the call (C URG LVL).

14. The token (27) of claim 9, 11, or 12 wherein the characterizing information about the call (INFO CALL) comprises the subject of the call (C_SUBJECT).

15. The token (27) of claim 9, 11, or 12 wherein upon reception of a notification message (NOT MSG) from a receiver communication device (20) a token (27) is inserted in, the token (27) executes a voicemail management applet (APLT) in which a message (VOICE MAIL MSG) to be displayed on the receiver communication device (20) is created, the message comprising at least the sender identification SNDR ID, at least one characterizing information about the call (INFO CALL).
